(19) United States
(12) Patent Application Publication
(10) Pub. No.: US 2024/0019969 A1
(43) Pub. Date: Jan. 18, 2024

(54) SELF-CAPACITANCE TOUCH CONTROL DISPLAY PANEL AND DISPLAY DEVICE

(71) Applicants: Wuhan China Star Optoelectronics Technology Co., Ltd., Wuhan, Hubei (CN); Wuhan China Star Optoelectronics Semiconductor Display Technology Co., Ltd., Wuhan, Hubei (CN)

(72) Inventor: Liang FANG, Wuhan, Hubei (CN)

(73) Assignees: Wuhan China Star Optoelectronics Technology Co., Ltd., Wuhan, Hubei (CN); Wuhan China Star Optoelectronics Semiconductor Display Technology Co., Ltd., Wuhan, Hubei (CN)

(21) Appl. No.: 17/421,410

(22) PCT Filed: Jun. 4, 2021
(86) PCT No.: PCT/CN2021/098244

§ 371 Date: Jul. 8, 2021

(30) Foreign Application Priority Data
May 20, 2021 (CN) 202110552955.8

(51) Int. Cl. G06F 3/044; G06F 3/041

(52) U.S. Cl. CPC G06F 3/0446; G06F 3/04164; G06F 3/0412; G06F 2203/04112

(57) ABSTRACT

A self-capacitance touch control display panel and a display device are disclosed. The self-capacitance touch control display panel includes a display area and a bezel area disposed on both sides of the display area in a column direction. The self-capacitance touch control display panel further includes a plurality of touch control sensing units disposed in the display area in rows and columns at intervals and a plurality of touch control signal lines. The touch control signal lines include a plurality of first touch control signal lines and a plurality of second touch control signal lines, and the first touch control signal lines are connected to the touch control sensing units adjacent to the bezel area and extend to the bezel area from the display area.

### FIELD OF INVENTION

The present disclosure relates to the field of touch control technologies, and more particularly, to a self-capacitance touch control display panel and a display device.

### BACKGROUND OF INVENTION

Display devices mainly include liquid crystal displays (LCDs), plasma display panels (PDPs), organic light-emitting diode (OLED) displays, and active-matrix organic light-emitting diode (AMOLED) displays, and the display devices have a broad application on vehicles, mobile phones, tablets, computers, and TV products.

In general, touch control functions have become one of standard configurations of most display devices, wherein, capacitive touch control panels are widely used. A basic principle thereof is to use a tool such as a finger or a stylus to generate capacitance with a touch control screen, and then an electrical signal formed by a capacitance change before and after the touch is used to confirm whether a panel is touched and to confirm touch coordinates.

Technical problem: the present disclosure provides a self-capacitance touch control display panel and a display device to solve a technical problem of self-capacitance touch control display panels having an overly low effective touch control area in current technology.

### SUMMARY OF INVENTION

An embodiment of the present disclosure provides a self-capacitance touch control display panel, which includes a display area and a bezel area disposed on both sides of the display area in a column direction, and further includes: a plurality of touch control sensing units disposed in the display area in rows and columns at intervals; and a plurality of touch control signal lines having one end connected to the touch control sensing units and another end connected to a touch control integrated circuit; wherein the touch control signal lines include a plurality of first touch control signal lines and a plurality of second touch control signal lines, the first touch control signal lines are connected to the touch control sensing units adjacent to the bezel area and extend to the bezel area from the display area, and the second touch control signal lines are connected to remaining touch control sensing units.

Optionally, in some embodiments of the present disclosure, the self-capacitance touch control display panel further includes a plurality of pixel units, a gap is defined between two adjacent pixel units, and the second touch control signal lines are correspondingly disposed in the gap.

Optionally, in some embodiments of the present disclosure, the touch control sensing units and the touch control signal lines are disposed in a same layer.

Optionally, in some embodiments of the present disclosure, the self-capacitance touch control display panel further includes a bonding area disposed on one side of the display area in a row direction, and the touch control integrated circuit is disposed in the bonding area.

Optionally, in some embodiments of the present disclosure, the first touch control signal lines in the bezel area are linear structures, and a spacing between two adjacent first touch control signal lines is less than a spacing between two adjacent second touch control signal lines.

Optionally, in some embodiments of the present disclosure, the second touch control signal lines are grid structures, and meshes of the grid structures correspond to the pixel units.

Optionally, in some embodiments of the present disclosure, the touch control sensing units and the touch control signal lines include a same metal material.

Optionally, in some embodiments of the present disclosure, the second touch control signal lines are curved structures, and the curved structures correspond to the gap between the pixel units.

Optionally, in some embodiments of the present disclosure, the second touch control signal lines are distributed between two adjacent columns of the touch control sensing units.

Correspondingly, an embodiment of the present disclosure further provides a display device, which includes the self-capacitance touch control display panel.

Beneficial effect: the beneficial effect of the present disclosure is that by extending the touch control signal lines on edges of the display area to the bezel area, the self-capacitance touch control display panel and the display device of the present disclosure can effectively improve an effective touch control area in the display area adjacent to the bezel area, thereby improving a touch control performance in the display area adjacent to the bezel area, which can relieve a problem of poor touch control performance in the display area adjacent to the bezel area.

### DESCRIPTION OF DRAWINGS

The following detailed description of specific embodiments of the present disclosure will make the technical solutions and other beneficial effects of the present disclosure obvious with reference to the accompanying drawings.

FIG. 1 is a schematic structural diagram of a display device according to an embodiment of the present disclosure.

FIG. 2 is a schematic planar diagram of a self-capacitance touch control display panel according to an embodiment of the present disclosure.

FIG. 3 is a schematic planar diagram of the self-capacitance touch control display panel according to a preferred embodiment of the present disclosure.

FIG. 4 is a schematic enlarged diagram corresponding to an area A in FIG. 2.

FIG. 5 is a schematic enlarged diagram corresponding to an area B in FIG. 2.

Elements in the drawings are designated by reference numerals listed below.
self-capacitance touch control display panel: 100; touch control sensing unit: 110;
first touch control signal line: 120; second touch control signal line: 130;
pixel unit: 140; touch control integrated circuit: 150;
display area: 101; bezel area: 102; and
bonding area: 103.

### DETAILED DESCRIPTION OF PREFERRED EMBODIMENTS

The technical solutions in the embodiments of the present disclosure will be clearly and completely described below with reference to the drawings in the embodiments of the present disclosure. Obviously, the described embodiments are only a part of the embodiments of the present disclosure, but not all the embodiments. Based on the embodiments in the present disclosure, all other embodiments obtained by those skilled in the art without creative efforts are within the scope of the present disclosure. In addition, it should be understood that the specific embodiments described herein are only used to illustrate and explain the disclosure and are not used to limit the disclosure. In the present disclosure, in the case of no explanation to the contrary, the orientation words used such as “on” and “under” usually refer to upper and lower directions of the device in actual use or working state, and specifically the directions in the drawings; and “inside” and “outside” refers to the outline of the device.

### EMBODIMENTS

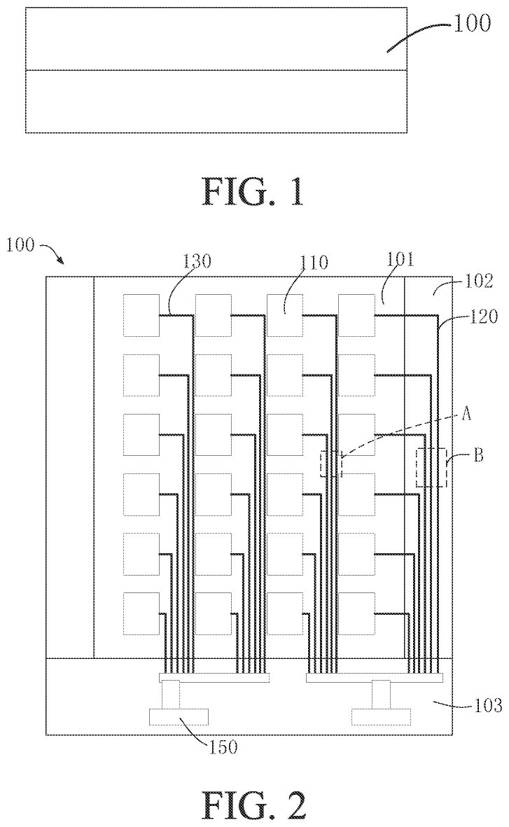

As shown in FIGS. 1 to 3, in this embodiment, A display device of the present disclosure includes a self-capacitance touch control display panel 100 and a backlight module. The self-capacitance touch control display panel 100 includes a plurality of touch control sensing units 110, a plurality of first touch control signal lines 120, a plurality of second touch control signal lines 130, a plurality of pixel units 140, and a touch control integrated circuit 150.

The self-capacitance touch control display panel 100 includes a display area 101, a bezel area 102, and a bonding area 103. Wherein, the bezel area 102 is disposed on both sides of the display area 101 in a column direction (a length direction), and the bonding area 103 is disposed under the display area 101 and the bezel area 102.

The touch control sensing units 110 are distributed in the display area 101 at intervals and are arranged in a matrix of rows and columns. Each of the touch control sensing units 110 in each column is correspondingly connected to one of touch control signal lines.

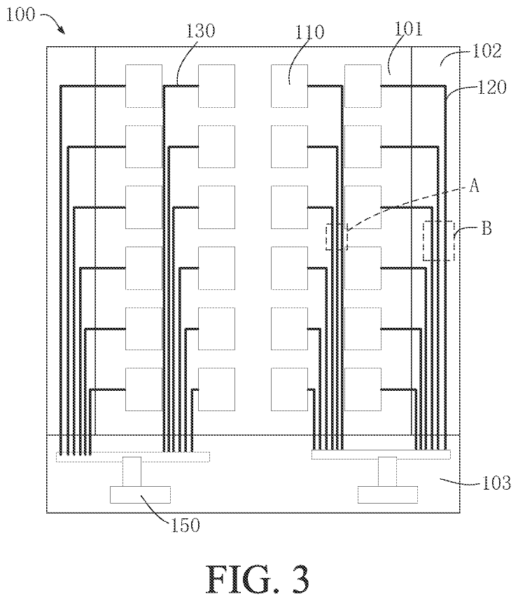

Specifically, as shown in FIG. 2, the touch control signal lines include the first touch control signal lines 120 and the second touch control signal lines 130. In this embodiment, the first touch control signal lines 120 and the second touch control signal lines 130 are disposed in a right side of each column of the touch control sensing units 110. Wherein, one end of the first touch control signal lines 120 is correspondingly connected to a rightmost column of the touch control sensing units 110, and the first touch control signal lines 120 are introduced to the bezel area 102 from the display area 101. The first touch control signal lines 120 in the bezel area 102 are straight lines in parallel to each other, and a spacing between two adjacent first touch control signal lines 120 is N. In other preferred embodiments of the present disclosure, as shown in FIG. 3, the touch control signal lines are distributed symmetrically in the column direction, that is, the end of the first touch control signal lines 120 is correspondingly connected to rightmost and leftmost touch control sensing units 110, and the first touch control signal lines 120 are introduced to the bezel area 102 from the display area 101. As shown in FIG. 5, since the pixel units for display do not exist in the bezel area 102, the first touch control signal lines 120 positioned in the bezel area 102 may be the straight lines parallel to each other. The spacing between the two adjacent first touch control signal lines 120 is N, which is less than a spacing between the second touch control signal lines 130 in the display area 101.

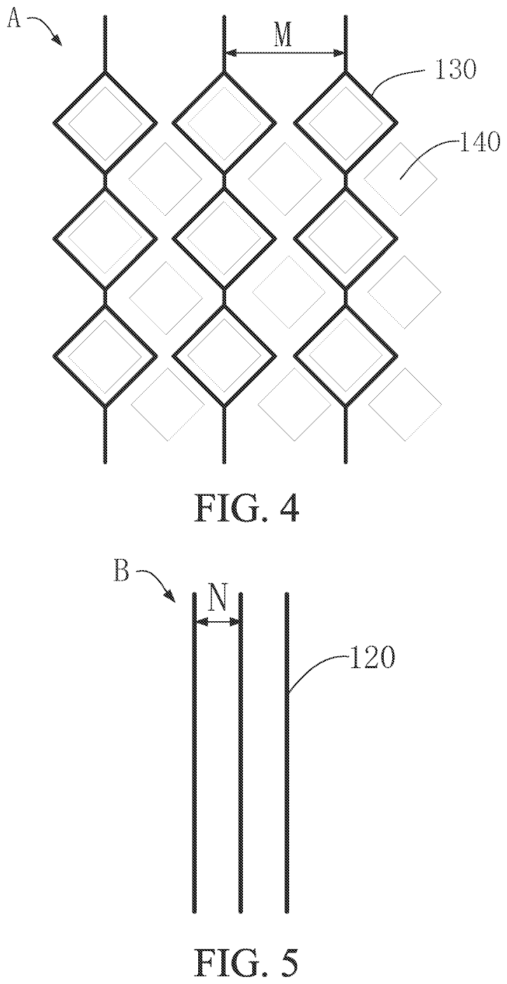

One end of the second touch control signal lines 130 is correspondingly connected to remaining touch control sensing units 110, and another end of the second touch control signal lines 130 is distributed on one side of each column of the touch control sensing units 110. The second touch control signal lines 130 are disposed in the display area 101, so in order to prevent the second touch control signal lines 130 from reducing brightness in the display area 101, the second touch control signal lines 130 need to avoid an area where the pixel units 140 are positioned. As shown in FIG. 4, specifically, the pixel units 140 are distributed in the display area 101 in an array, and a gap is defined between two adjacent pixel units 140. In this embodiment, the second touch control signal lines 130 are designed as curved lines to surround the pixel units 140, the spacing between two adjacent second touch control signal lines 130 is M, and a value of M is greater than a value of N. In other preferred embodiments of the present disclosure, the second touch control signal lines 130 are designed as polylines to avoid the pixel units 140. That is, the second touch control signal lines 130 are disposed in the gap between the pixel units 140, thereby preventing poor influences on pixel display.

The first touch control signal lines 120 designed as the straight lines extend the first touch control signal lines 120 from the display area 101 to the bezel area 102, thereby improving an effective touch control area in the display area 101 adjacent to the bezel area 102 and improving a touch control performance in the display area 101 adjacent to the bezel area 102.

The touch control integrated circuit 150 is disposed in the bonding area 103, and another end of the first touch control signal lines 120 away from the touch control sensing units 110 extends from the bezel area 102 to the bonding area 103 and is integrated and connected to the touch control integrated circuit 150. The another end of the second touch control signal lines 130 away from the touch control sensing units 110 extends from the display area 101 to the bonding area 103 and is connected to the touch control integrated circuit 150. The touch control integrated circuit 150 is configured to provide touch control driving signals and detecting touch control signals, thereby realizing touch control functions of the self-capacitance touch control display panel 100.

A beneficial effect of this embodiment is that by extending the touch control signal lines on edges of the display area to the bezel area, the self-capacitance touch control display panel and the display device in this embodiment can effectively improve the effective touch control area in the display area adjacent to the bezel area, thereby improving the touch control performance in the display area adjacent to the bezel area, which can relieve a problem of poor touch control performance in the display area adjacent to the bezel area.

The description of the above embodiments is only for helping to understand the technical solution of the present disclosure and its core ideas, and it is understood that many changes and modifications to the described embodiment can be carried out without departing from the scope and the spirit of the disclosure that is intended to be limited only by the appended claims.

What is claimed is:

1. A self-capacitance touch control display panel, comprising a display area and a bezel area disposed on both sides of the display area in a column direction, and further comprising:
a plurality of touch control sensing units disposed in the display area in rows and columns at intervals; and
a plurality of touch control signal lines having one end connected to the touch control sensing units and another end connected to a touch control integrated circuit;
wherein the touch control signal lines comprise a plurality of first touch control signal lines and a plurality of second touch control signal lines, the first touch control signal lines are connected to the touch control sensing units adjacent to the bezel area and extend to the bezel area from the display area, and the second touch control signal lines are connected to remaining touch control sensing units.

2. The self-capacitance touch control display panel according to claim 1, further comprising a plurality of pixel units, wherein a gap is defined between two adjacent pixel units, and the second touch control signal lines are correspondingly disposed in the gap.

3. The self-capacitance touch control display panel according to claim 1, wherein the touch control sensing units and the touch control signal lines are disposed in a same layer.

4. The self-capacitance touch control display panel according to claim 1, further comprising a bonding area disposed on one side of the display area in a row direction, wherein the touch control integrated circuit is disposed in the bonding area.

5. The self-capacitance touch control display panel according to claim 1, wherein the first touch control signal lines in the bezel area are linear structures, and a spacing between two adjacent first touch control signal lines is less than a spacing between two adjacent second touch control signal lines.

6. The self-capacitance touch control display panel according to claim 2, wherein the second touch control signal lines are grid structures, and meshes of the grid structures correspond to the pixel units.

7. The self-capacitance touch control display panel according to claim 1, wherein the touch control sensing units and the touch control signal lines comprise a same metal material.

8. The self-capacitance touch control display panel according to claim 2, wherein the second touch control signal lines are curved structures, and the curved structures correspond to the gap between the pixel units.

9. The self-capacitance touch control display panel according to claim 1, wherein the second touch control signal lines are distributed between two adjacent columns of the touch control sensing units.

10. A display device, comprising the self-capacitance touch control display panel according to claim 1.

11. The display device according to claim 10, further comprising a plurality of pixel units, wherein a gap is defined between two adjacent pixel units, and the second touch control signal lines are correspondingly disposed in the gap.

12. The display device according to claim 10, wherein the touch control sensing units and the touch control signal lines are disposed in a same layer.

13. The display device according to claim 10, further comprising a bonding area disposed on one side of the display area in a row direction, wherein the touch control integrated circuit is disposed in the bonding area.

14. The display device according to claim 10, wherein the first touch control signal lines in the bezel area are linear structures, and a spacing between two adjacent first touch control signal lines is less than a spacing between two adjacent second touch control signal lines.

15. The display device according to claim 11, wherein the second touch control signal lines are grid structures, and meshes of the grid structures correspond to the pixel units.

16. The display device according to claim 10, wherein the touch control sensing units and the touch control signal lines comprise a same metal material.

17. The display device according to claim 11, wherein the second touch control signal lines are curved structures, and the curved structures correspond to the gap between the pixel units.

18. The display device according to claim 10, wherein the second touch control signal lines are distributed between two adjacent columns of the touch control sensing units.
